(19) United States
(12) Patent Application Publication
(10) Pub. No.: US 2026/0036774 A1
(43) Pub. Date: Feb. 5, 2026

(54) OPTICAL CABLE AND OPTICAL CABLE ASSEMBLY AND OPTICAL TRANSMISSION APPARATUS AND ACTIVE OPTICAL TRANSCEIVER

(71) Applicant: AIP Inc., New Taipei City (TW)

(72) Inventor: Chia LEE, New Taipei City (TW)

(21) Appl. No.: 19/356,328

(22) Filed: Oct. 13, 2025

Related U.S. Application Data
(63) Continuation-in-part of application No. 18/510,668, filed on Nov. 16, 2023.
(60) Provisional application No. 63/528,933, filed on Jul. 26, 2023.
(60) Provisional application No. 63/708,463, filed on Oct. 17, 2024.
(60) Provisional application No. 63/770,058, filed on Mar. 11, 2025.

(51) Int. Cl. G02B 6/44; G02B 6/38; H04B 10/40

(52) U.S. Cl. CPC G02B 6/443; G02B 6/3869; G02B 6/3881; G02B 6/3885; H04B 10/40

(57) ABSTRACT

An optical cable assembly and an optical transmission apparatus are provided. The optical cable assembly includes an optical cable and a connecting base. The optical transmission apparatus includes the optical cable assembly and an optical coupling member. The optical cable includes a coupling head and a connecting member mounted to a cable member and including a plurality of connecting walls and first fastening portions. The connecting base defines a fastening groove and includes a fastening member disposed in the fastening groove. The first fastening portions are detachably fastened with the fastening member. The optical coupling member includes a waveguide device positioned to correspond to the fastening groove and configured in optical connection with optical fibers included in the optical cable.

### CROSS REFERENCE TO RELATED APPLICATIONS

This application claims the benefit of U.S. provisional patent application Ser. No. 63/770,058, filed Mar. 11, 2025, the entirety of which is incorporated by reference herein.

This application claims the benefit of U.S. provisional patent application Ser. No. 63/708,463, filed Oct. 17, 2024, the entirety of which is incorporated by reference herein.

This application is a continuation-in-part of Ser. No. 18/510,668, filed Nov. 16, 2023, which claims the priority of U.S. provisional patent application Ser. No. 63/528,933, filed Jul. 26, 2023, the entireties of which are incorporated by reference herein.

### BACKGROUND OF INVENTION

### 1. Field of Invention

The present invention relates to a technical field of optical cables, and particularly to an optical cable, an optical cable assembly, an optical transmission apparatus, and an active optical transceiver.

### 2. Related Art

Optoelectronic integrated circuits (OEICs), using photons instead of electrons for calculation and data transmission in integrated circuits, bring great benefits to the development of industries requiring high-performance data exchange, long-distance interconnection, 5G facilities, and computing equipment. To manage large volumes of data, conventional switches or servers are required to process data for as many connected devices as possible via optical cables. However, because switches or servers have limited space for connecting traditional optical cables, and a minimum distance must be maintained between adjacent cables, the number of optical cables that can be connected cannot be increased. In addition, conventional optical cables are directly connected to coupling mechanisms on OEICs, which results in unstable connections, makes them susceptible to optical transmission issues, and is not suitable for repeated plugging and unplugging.

### SUMMARY OF INVENTION

An object of the present application is to provide an optical cable and an optical cable assembly capable of being plugged in different orientations to make the most of the area for a plurality of optical cables.

Another object of the present application is to provide an optical transmission apparatus and an active optical transceiver capable of repeatedly detachably connecting to a mating device.

To achieve the above-mentioned objects, the present application provides an optical cable adapted to optically connect to a waveguide device. The optical cable includes an optical cable including at least a cable member including a plurality of optical fibers and a cable jacket covering the optical fibers; a coupling head positioned at end portions of the optical fibers in optical alignment with the waveguide device; and a connecting member mounted to the cable member and covering part of the cable jacket. The connecting member includes a plurality of connecting walls and first fastening portions, the connecting walls are spaced apart from each other with respect to the coupling head, and the first fastening portions are disposed on the connecting walls, respectively.

Optionally, the connecting walls are oppositely located at a top side and a bottom side of the connecting member, and the first fastening portions are arranged in a vertical direction with respect to the coupling head.

Optionally, the connecting walls are oppositely located at a left side and a right side of the connecting member, and the first fastening portions are arranged in a horizontal direction with respect to the coupling head.

Optionally, each of the connecting walls defines a connecting groove protruding inwardly from the connecting wall, and the first fastening portion protrudes outward from a surface of the connecting groove.

Optionally, each of the connecting walls further defines two positioning slots arranged on opposite sides of the connecting groove and spaced apart from the first fastening portion.

Optionally, the connecting groove extends in a direction in which the optical cable is optically connected to the waveguide device and defines a groove opening passing through an end of the connecting wall adjacent to the coupling head.

Optionally, a width of the connecting groove is greater than half a width of the connecting wall.

Optionally, the present application further provides an optical cable assembly includes the optical cable and a connecting base defining a fastening groove extending through the connecting base and including a fastening member disposed in the fastening groove, wherein the waveguide device is adapted to position between the connecting base and the coupling head, and the connecting member is detachably fastened with the fastening member in the fastening groove to optically connect the coupling head with the waveguide device.

Optionally, the fastening member includes a pair of arm elements and a plurality of second fastening portions symmetrically formed on the arm elements to be detachably fastened with the first fastening portions.

Optionally, the optical cable includes a plurality of the cable members, the coupling head includes an outer cover and a plurality of ferrule elements covered with the outer cover, the optical fibers of each of the cable members are terminated at a corresponding one of the ferrule elements, part of the outer cover is housed in the connecting member, and another part of the outer cover extends out of the connecting member.

The present application further provides an optical transmission apparatus, including the optical cable assembly, wherein the first fastening portions are detachably fastened with the fastening member, and an optical coupling member includes a waveguide device positioned to correspond to the fastening groove and configured in optical connection with the optical fibers.

Optionally, the optical coupling member further includes a mounting base including a positioning groove extending through part of the mounting base, and the waveguide device is positioned in the positioning groove.

Optionally, the fastening member includes a pair of arm elements and a plurality of second fastening portions symmetrically formed on the arm elements to be detachably fastened with the first fastening portions.

Optionally, the optical cable includes a plurality of the cable members, the coupling head includes an outer cover and a plurality of ferrule elements covered with the outer cover, the optical fibers of each of the cable members are terminated at a corresponding one of the ferrule elements, part of the outer cover is housed in the connecting member, and another part of the outer cover extends out of the connecting member.

Optionally, the present application further provides an active optical transceiver includes the optical transmission apparatus, a housing, and a load board disposed in the housing, wherein the waveguide device is positioned on the load board, and part of the optical transmission apparatus is disposed in the housing.

In the present application, the optical cable assembly and the optical transmission apparatus in the embodiments of the present application provide the secure connection of the optical cable to the connecting base, thereby achieving reliable optical connection with the waveguide device and the photonic substrate. In addition, the configuration of the connection between the connecting member and the connecting base reduces the spacing between adjacent ones of the optical cable assemblies, thus overcoming the problem of the spacing limitation in prior art. Furthermore, the optical cable is indirectly coupled with the photonic substrate through the waveguide device and the mounting base, thereby preventing the photonic substrate from being damaged by the plugging and unplugging force and facilitating repeated plugging and unplugging of the optical cable.

### BRIEF DESCRIPTION OF DRAWINGS

To describe the technical solutions in the embodiments of the present invention, the following briefly introduces the accompanying drawings for describing the embodiments. Apparently, the accompanying drawings in the following description show merely some embodiments of the present invention, and a person skilled in the art may still derive other drawings from these accompanying drawings without creative efforts.

FIG. 1 is a schematic exploded view of an active optical cable in an embodiment of the present application.

FIG. 2 is a schematic assembly view of FIG. 1.

FIG. 3A is a schematic exploded view of an optical cable assembly in an embodiment of the present application.

FIG. 3B is a schematic assembly view of the optical cable assembly of FIG. 3A.

FIG. 3C schematically shows a waveguide device positioned in a connecting base of the optical cable assembly of FIG. 3A.

FIG. 4A is a schematic exploded view of an optical cable assembly in an embodiment of the present application.

FIG. 4B is a schematic assembly view of the optical cable assembly of FIG. 4A.

FIG. 5A is a schematic assembly view of an active optical cable in an embodiment of the present application.

FIG. 5B is a schematic enlarged perspective view showing an optical coupling member in an embodiment of the present application.

FIG. 5C is a schematic structural view showing an optical cable to be connected to the optical coupling member of FIG. 5B in an embodiment of the present application.

FIG. 5D is a schematic structural view showing an optical cable to be connected to an optical coupling member in an embodiment of the present application.

FIG. 5E is a schematic structural view showing a connecting base disposed in an active optical cable is connected with an optical cable in an embodiment of the present application.

FIG. 6 is a schematic structural view of an optical cable in another embodiment of the present application.

FIG. 7 is a schematic structural view of an optical cable in another embodiment of the present application.

FIG. 8 is a schematic structural view showing a plurality of optical cables detachably connected to a mating device in an embodiment of the present application.

FIG. 9 is a schematic structural view showing an optical cable to be connected to an optical coupling member disposed in the mating device.

### DESCRIPTION OF PREFERRED EMBODIMENTS

The following embodiments refer to the accompanying drawings for exemplifying specific implementable embodiments of the present invention. Directional terms described by the present invention, such as upper, lower, front, back, left, right, inner, outer, side, etc., are only directions by referring to the accompanying drawings, and thus the used directional terms are used to describe and understand the present invention, but the present invention is not limited thereto.

It should be understood that, although the terms first, second, etc. may be used herein to describe various elements, these elements should not be limited by these terms. Unless indicated otherwise, these terms are only used to distinguish one element from another element. Thus, for example, a first element, a first component, or a first section could be termed as a second element, a second component or a second section without departing from the teachings of the present application.

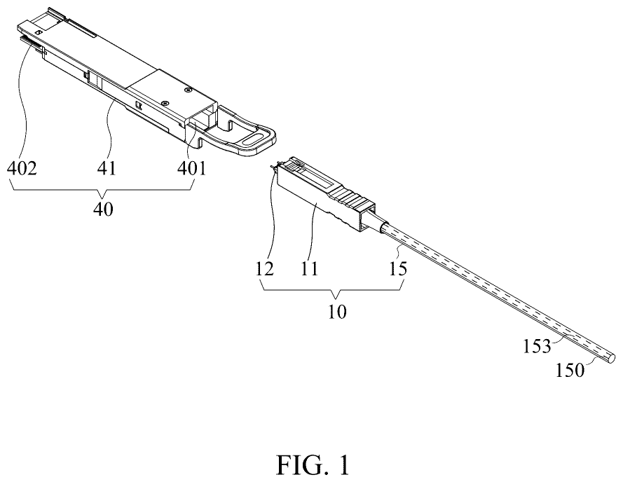

The present application provides an optical cable assembly and an optical transmission apparatus for optical signal transmission between an external applied device and a data processing device. Referring to FIG. 1, which is a schematic exploded view of an active optical cable includes an optical cable 10 and an optical transceiver 40 according to an embodiment of the present application, the optical cable 10 is detachably connected to the optical transceiver 40 to form an active optical cable, which is pluggable to a data processing device (not shown), such as servers or switches. As shown in FIG. 1, in some embodiments, the optical cable 10 includes a connecting member 11, a coupling head 12, and a cable member 15. The cable member 15 serves as a multi-fiber cable and includes a plurality of optical fibers 150 and a cable jacket 153 covering the optical fibers 150. The coupling head 12 is positioned at end portions of the optical fibers 150, which may be arranged in rows and terminated and exposed at one end of the coupling head 12. The connecting member 11 is casing-shaped and mounted to the cable member 15 to cover part of the cable jacket 153.

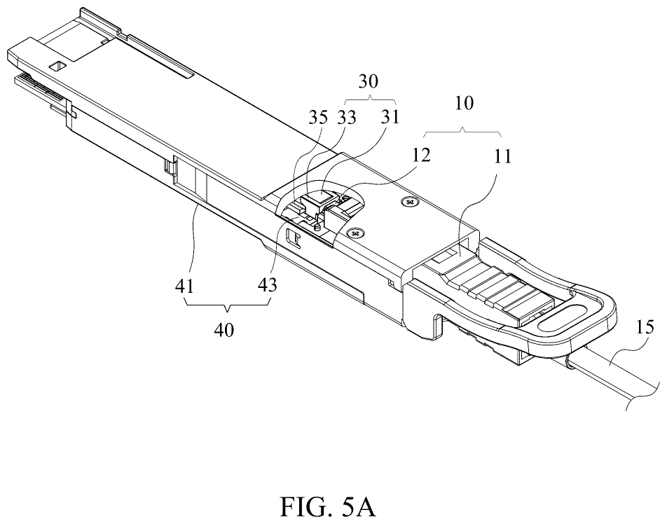

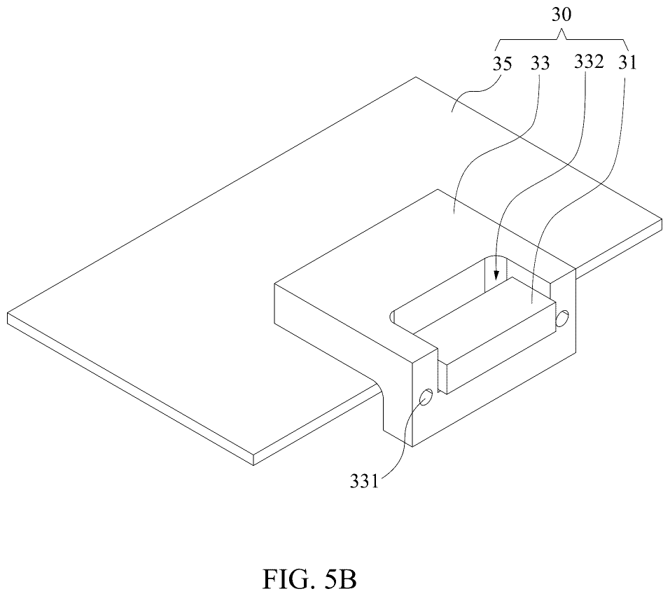

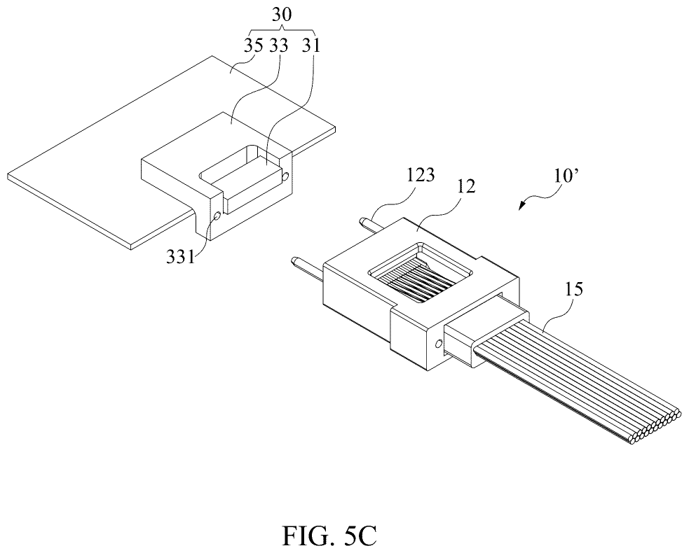

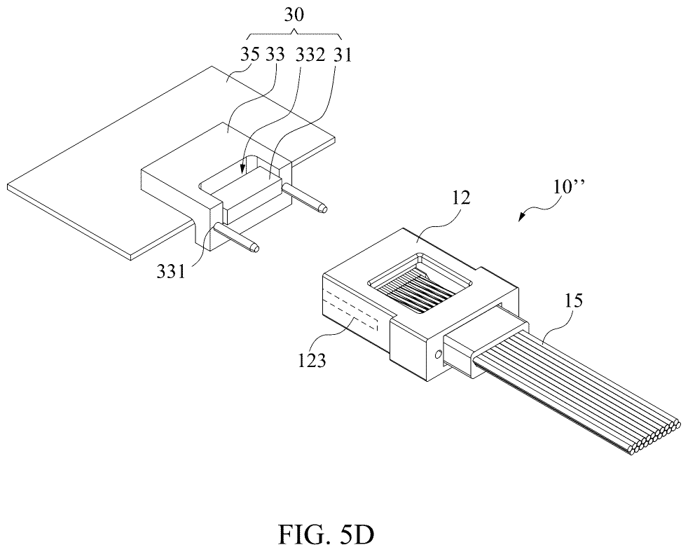

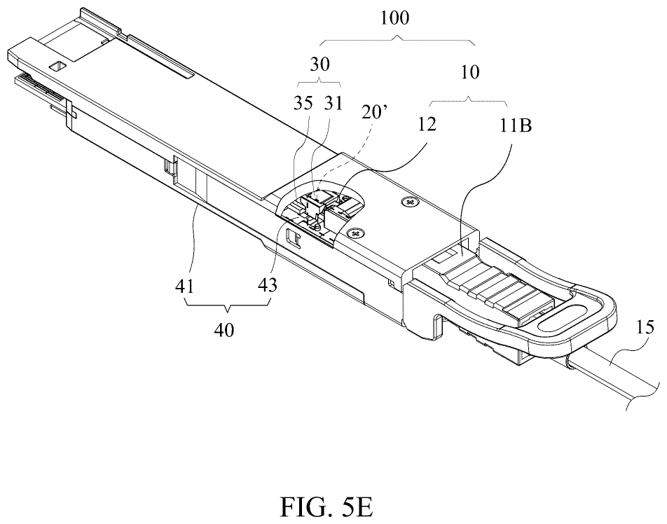

As shown in FIG. 1, the optical transceiver 40 includes a housing 41, a load board 43 (as shown in FIG. 5A, described later), an insertion hole 401, and a front connecting end 402. The insertion hole 401 extends through the housing 41 and configured for the insertion of the connecting member 11 of the optical cable 10. The front connecting end 402 is located at an end of the housing 41 opposite to the insertion hole 401 for electrical connection with the data processing device. In some embodiments, electronic integrated circuits and photonic integrated circuits (not shown) are provided on the load board 43 and are co-packaged as co-packaged optics (CPO) so that the optical transceiver 40 enables electrical-to-optical signal and optical-to-electrical signal conversion.

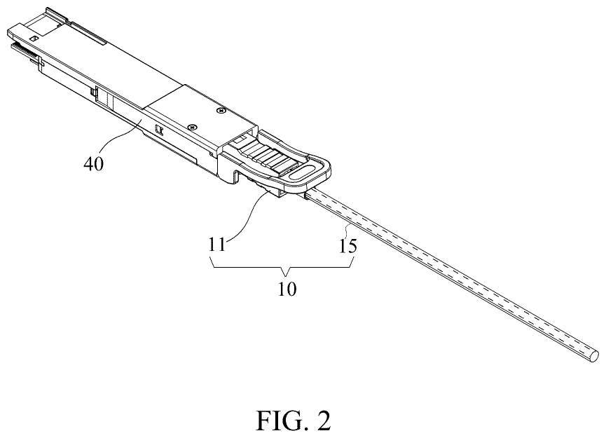

As shown in FIG. 2, the connecting member 11 is structured to be detachably connected to the optical transceiver 40 such that the connecting member 11 functions as a push-pull connector for ease connection between the optical cable 10 and the optical transceiver 40. In detail, the optical transceiver 40 is electrically connected to the data processing device through the front connecting end 402. The connecting member 11 is plugged into the optical transceiver 40 from the insertion hole 401 so that electrical signals transmitted from the data processing device are converted into optical signals by the optical transceiver 40 and output to the applied device through the cable member 15. Likewise, optical signals transmitted from the cable member 15 are converted into electrical signals to be input to the data processing device through the optical transceiver 40.

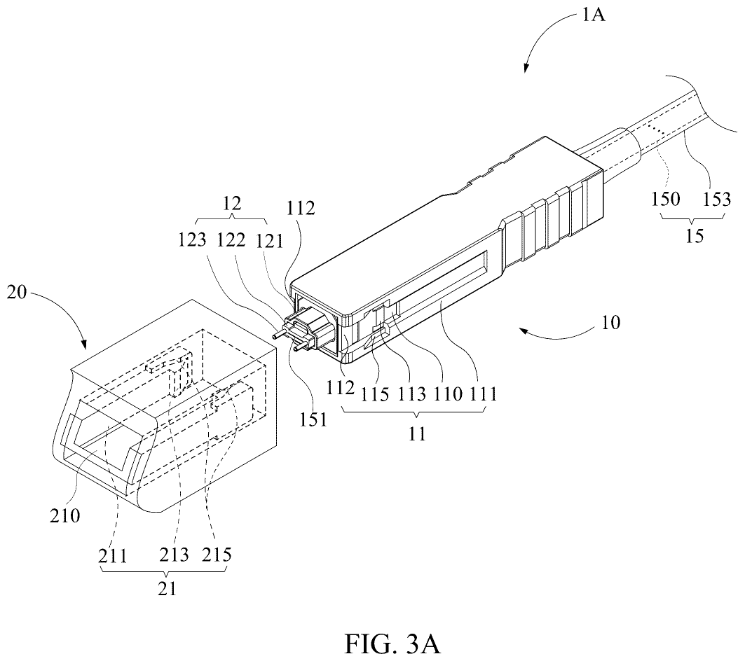

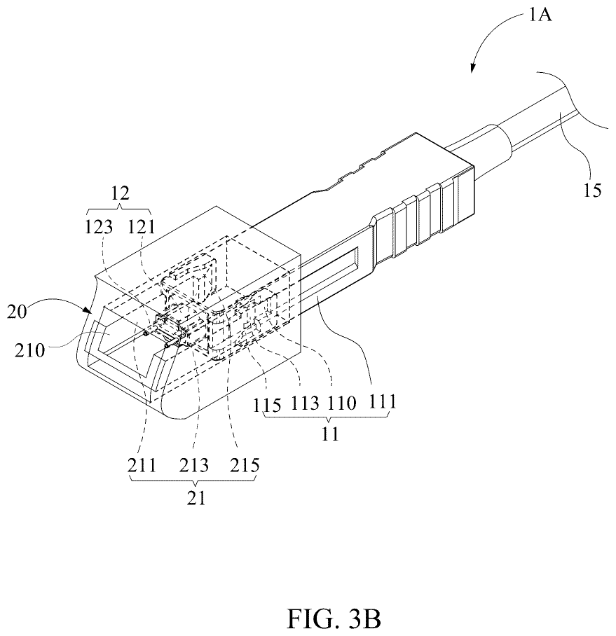

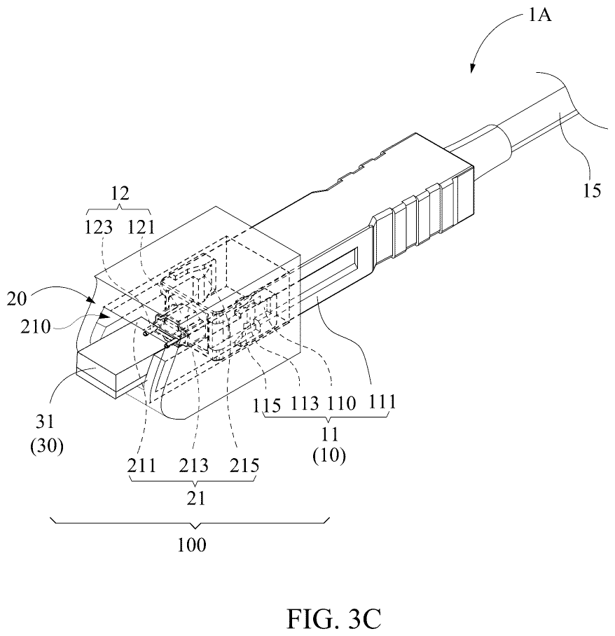

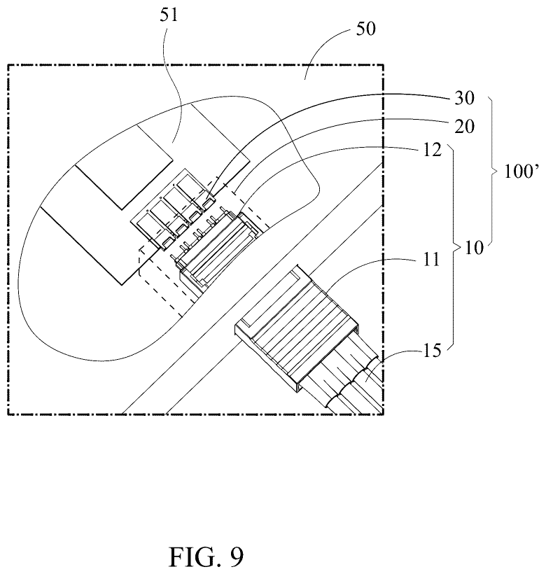

Referring to FIG. 3A, showing a schematic exploded view of an optical cable assembly 1A according to an embodiment of the present application, the optical cable assembly 1A includes the optical cable 10 and a connecting base 20. The connecting member 11 is detachably connected to the connecting base 20 disposed at a mating device 50 (as shown in FIG. 9, which will be described later) or at the housing 41 of the optical transceiver 40 (as shown in FIG. 5E, which will be described later) and forms an optical cable assembly 1A with the connecting base 20. In detail, the connecting member 11 includes a plurality of connecting walls 111, a plurality of first fastening portions 113, and a plurality of positioning slots 115. As shown in FIG. 3A, the connecting walls 111 are spaced apart from each other with respect to the coupling head 12. The connecting member 11 covers one end of the cable member 15 and part of the coupling head 12 such that the coupling head 12 protrudes frontward from a front side of the connecting member 11. The first fastening portions 113 are disposed on the connecting walls 111, respectively.

In detail, as shown in FIG. 3A, the coupling head 12 is positioned at end portions 151 of the optical fibers 150 and includes an outer cover 121, a ferrule element 122, and two positioning elements 123. Part of the outer cover 121 is housed in the connecting member 11, and another part of the outer cover 121 extends out of the connecting member 11. The ferrule element 122 is covered with the outer cover 121, and the positioning elements 123 are formed on the ferrule element 122. Each of the optical fibers 150 of the cable member 15 extends to the outer cover 121 and is terminated and exposed at one end of the ferrule element 122 to form the end portion 151. In this embodiment, the connecting walls 111 are oppositely located on left and right sides of the connecting member 11, with the coupling head 12 located between the connecting walls 111 in such a way that the connecting walls 111 and the coupling head 12 are arranged in a horizontal direction with respect to each other, while the end portions 151 of the optical fibers 150 are arranged in a predetermined layout, such as the end portions 151 are arranged in a row in the horizontal direction.

As shown in FIG. 3A, each of the connecting walls 111 defines a connecting groove 110 protruding inwardly from the connecting wall 111. The connecting groove 110 extends in a direction in which the optical cable 10 is plugged into the connecting base 20. In detail, the connecting groove 110 forms a groove opening 112 passing through an end of the connecting wall 111 adjacent to the coupling head 12. The first fastening portion 113 is shaped to be fastened with the connecting base 20. In detail, as shown in FIG. 3A, the first fastening portion 113 is formed on the connecting groove 110 and protrudes outward from a surface of the connecting groove 110. In other embodiments, the first fastening portion 113 may protrude inward from the surface of the connecting groove 110, depending on different fastening types. As shown in FIG. 3A, the first fastening portions 113 are arranged in a horizontal direction with respect to the coupling head 12. Two positioning slots 115 are formed on each of the connecting walls 111 and spaced apart from the first fastening portion 113. In detail, each of the positioning slots 115 forms a recessed space with an outer surface of the connecting wall 111. The connecting walls 111 are symmetrically provided with the first fastening portions 113 and the two positioning slots 115, respectively.

As shown in FIG. 3A, in this embodiment, the two positioning elements 123 are oppositely arranged on left and right sides of the ferrule element 122, and the end portions 151 of the optical fibers 150 are arranged between the positioning elements 123. In detail, the positioning elements 123 are configured to be in a snug-fit engagement with a corresponding structure of an optical coupling member 30 (as shown in FIG. 5A, described later). Preferably, the positioning elements 123 are post-like in shape.

Still referring to FIG. 3A, the connecting base 20 is configured to connect with and secure the connecting member 11. In some embodiments, the connecting base 20 defines a fastening groove 210 extending through the connecting base 20 and includes a fastening member 21 disposed in the fastening groove 210. In detail, the fastening member 21 includes a pair of arm elements 211, a plurality of second fastening portions 213, and a plurality of guiding protrusions 215. In detail, the pair of arm elements 211 are spaced apart from each other and symmetrically arranged in the horizontal direction with respect to each other.

As shown in FIG. 3A, the second fastening portions 213 are symmetrically formed and convex on sides of the arm elements 211 to be detachably fastened with the first fastening portions 113, respectively. In this embodiment, each of the second fastening portions 213 is hook-like in shape and sized to fit a width of the groove opening 112. Each of the arm elements 211 is provided with the guiding protrusion 215 formed on an end of the arm element 211. The guiding protrusion 215 protrudes laterally from edges of the arm element 211 such that the guiding protrusion 215 makes the end of the arm element 211 relatively large in size. In detail, portions of the guiding protrusion 215 on upper and lower sides of the arm element 211 are recessed to at an oblique angle in such a way that the guiding protrusion 215 gradually decreases in thickness, forming an oblique surface that matches the positioning slot 115, thereby guiding the connecting member 11 of the optical cable 10 to be easily plugged in position, and limiting the length of insertion travel of the connecting member 11 of the optical cable 10.

Referring to FIG. 3B in combination with FIG. 3A, FIG. 3B shows a schematic assembly view of the optical cable assembly 1A of FIG. 3A. In assembly, the optical cable 10 is plugged into the connecting base 20 such that connecting member 11 is inserted into the fastening groove 210, along with the process that the groove openings 112 are guided by and pass the second fastening portions 213 until the first fastening portions 113 are engaged with the second fastening portions 213, and the guiding protrusions 215 are located at the positioning slots 115. Preferably, the connecting groove 110 has a width greater than half a width of the connecting wall 111 in order to increase an engaging area between the fastening member 21 and the connecting member 11, thereby ensuring the secure connection between the optical cable 10 and the connecting base 20. After the optical cable 10 is plugged into the connecting base 20 to server as the optical cable assembly 1A, the optical cable 10 is in position to be optically connected to a waveguide device 31 (as shown in FIG. 3C, which will be described later).

Referring to FIG. 3C, schematically showing the waveguide device 31 detachably positioned in the connecting base 20 of the optical cable assembly 1A of FIG. 3A, the waveguide device 31 as a part of an optical coupling member 30 (which will be described in detail later) is positioned between the connecting base 20 and the coupling head 12. In detail, the waveguide device 31 is positioned to correspond to the fastening groove 210 and configured in optical connection with the optical fibers 150. It should be noted that a substrate for supporting the waveguide device 31 is omitted for clarity in FIG. 3C. In some embodiments, the waveguide device 31 may be provided in an optoelectronic device, such as an optical transceiver 40 (as shown in FIG. 5A below) or a mating device 50 such as a data processing device (as shown in FIG. 9 below, which will be described later), that is, the waveguide device 31 is configured to couple light signals from the optical fibers 150 to enable optical transmission between the optical cable 10 and the optical transceiver 40 or the mating device 50. As shown in FIG. 3C, the optical cable 10, the connecting device 20, and the optical coupling member 30 cooperatively form an optical transmission apparatus 100.

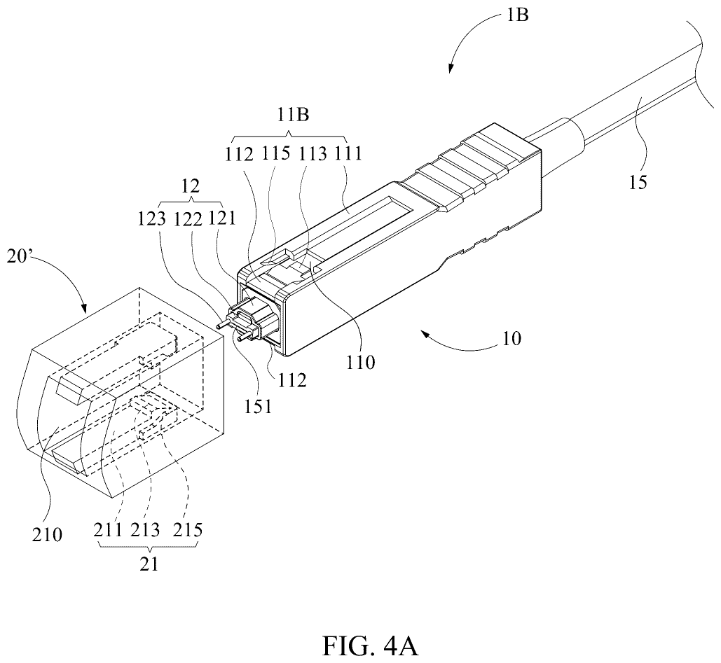

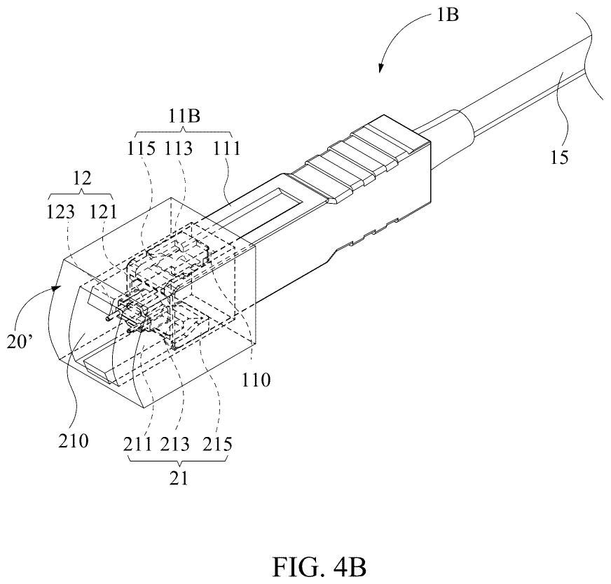

Referring to FIG. 4A, in this embodiment, a connecting member 11B including the optical cable 10 and a connecting base 20′ has a similar structure to the connecting member 11 shown in FIG. 3A. In detail, the connecting member 11B is mainly different from the connecting member 11 in their orientation. It should be noted that the components of the connecting member 11B, which are the same as those of the connecting member 11A, will not be described in detail here. As shown in FIG. 4A, the connecting walls 111 are oppositely arranged on top and bottom sides of the connecting member 11, with the coupling head 12 located between the connecting walls 111, in such a way that the connecting walls 111 and the coupling head 12 are arranged in a vertical direction with respect to each other, while the end portions 151 of the optical fibers as shown in FIG. 4A are arranged in the same layout as the predetermined layout in which the end portions 151 are arranged as shown in FIG. 3A.

As shown in FIG. 4A, similarly, in this embodiment, the connecting base 20′ has a similar structure to the connecting base 20 shown in FIG. 3A and is mainly different from the connecting base 20 in their orientation. In detail, as shown in FIG. 4A, the pair of arm elements 211 of the fastening member 21 are disposed in the fastening groove 210 and spaced apart from each other such that the arm elements 211 are arranged in the vertical direction with respect to each other. The connecting member 11B is insertable to the connecting base 20′ and forms the optical cable assembly 1B with the connecting base 20′.

Referring to FIG. 4B in combination with FIG. 4A, FIG. 4B shows a schematic assembly view of the optical cable assembly 1B of FIG. 4A. In assembly, the optical cable 10 is plugged into the connecting base 20′ through the process that the groove openings 112 are guided by and pass the second fastening portions 213 until the first fastening portions 113 are engaged with the second fastening portions 213, and the guiding protrusions 215 are located at the positioning slots 115. After the optical cable 10 is plugged into the connecting base 20′ to server as the optical cable assembly 1B, the optical cable 10 is in position to be optically connected to the waveguide device 31 (as shown in FIG. 3C). As shown in FIGS. 4A and 4B, the engagement between the connecting member 11B and the fastening member 21 in the vertical direction can reduce an area for the arrangement of a plurality of the optical cable assembly 1B in terms of a transverse spacing between adjacent ones of the optical cable assembly 1B. Likewise, the waveguide device 31 may also be positioned to correspond to the fastening groove 210 of the connecting base 20′ and optically coupled with the coupling head 12.

Referring to FIG. 5A, which is a schematic assembly view of an active optical cable includes an optical cable 10 and an optical transceiver 40 in an embodiment of the present application, as shown in FIG. 5A, a portion of an upper casing of the optical transceiver 40 is omitted to show internal arrangement of the optical transceiver 40. In some embodiments, the optical coupling member 30 includes the waveguide device 31 and a mounting base 33. The mounting base 33 is disposed on a photonic substrate 35, and the waveguide device 31 is fixed in the mounting base 33, and the photonic substrate 35 is disposed on the load board 43 installed inside the optical transceiver 40. In detail, the coupling head 12 is positioned in optical alignment with the waveguide device 31. In this embodiment, the optical cable 10 is connected to the optical coupling member 30 by means of the connecting member 11 and the connecting base, which is integrally formed with the housing 41 of the optical transceiver 40.

Referring to FIG. 5B, which is a schematic enlarged perspective view illustrating an optical coupling member 30 according to an embodiment of the present application, the optical coupling member 30 includes a waveguide device 31 and a mounting base 33. In detail, the mounting base 33 includes a plurality of fixing portions 331 and a positioning groove 332 extending through part of the mounting base 33. The mounting base 33 is mounted on a photonic substrate 35 where the positioning groove 332 communicates with the photonic substrate 35, and the waveguide device 31 is disposed in the positioning groove 332 for optical coupling with an optical transmission portion (not shown) on the photonic substrate 35.

In some embodiments, the waveguide device 31 is made of a material containing, for example, silica. Alternatively, the waveguide device 31 may be made of a material containing silicon-on-insulator (SOI), lithium niobate (LiNbO3), or polymers. In some embodiments, the waveguide device 31 may be formed using a material, such as fused silica, quartz, glass, borosilicate glass, etc. It should be noted that the waveguide device 31 includes a planar lightwave circuit (PLC). In some embodiments, the planar lightwave circuit may be configured in various ways, including, but not limited to, a straight line circuit, a splitter circuit, an arrayed waveguide grating wavelength multiplexer, and a cross connect-type circuit. Different types of waveguide circuits or devices can be utilized for the planar lightwave circuit in the embodiments of the present application. The photonic substrate 35 is a silicon photonic (SiPh) substrate.

Referring to FIG. 5C, an optical cable 10′ (with the connecting member 11 omitted for clarity to show the coupling head 12 disposed inside the connecting member 11) is provided to be optically and detachably connected to the optical coupling member 30. In this embodiment, a coupling head 12 includes a pair of positioning elements 123 arranged on a front side of the coupling head 12. The mounting base 33 mounted on the photonic substrate 35 includes two fixing portions 331 formed on a surface of the mounting base 33 facing the coupling head 12. The two fixing portions 331 are sized and shaped to allow for tight fit with the positioning elements 123, respectively. Preferably, the positioning elements 123 are post-like in shape and the fixing portions 331 are hole-like in shape. The optical cable 10′ is optically and precisely connected to the optical coupling member 30 through the tight fit between the positioning elements 123 and the fixing portions 331, so that the optical signals can be transmitted between the waveguide device 31 and the cable member 15.

Referring to FIG. 5D, in this embodiment, an optical cable 10″ is provided to be optically and detachably connected to the optical coupling member 30. Two positioning elements 123 are formed in the coupling head 12 and are hole-like in shape. The mounting base 33 includes two fixing portions 331, which are post-like in shape. Likewise, through the tight fit between the positioning elements 123 and the fixing portions 331, the optical cable 10″ is optically and precisely connected to the optical coupling member 30.

Referring to FIG. 5E, the present application provides an optical transmission apparatus 100 includes the optical cable 10, the connecting base 20′, and the optical coupling member 30. In detail, the connecting base 20′ as shown in FIGS. 4A and 4B is disposed in the optical transceiver 40 for detachably securing the connecting member 11B of the optical cable 10. It should be noted that the connecting base 20′ is illustrated with dashed lines for clarity of showing the internal components of the optical transceiver 40. As shown in FIG. 5E, the connecting base 20′ is positioned in front of the waveguide device 31 in such a way that the optical fibers 150 are in optical alignment with the waveguide device 31 after the connecting member 11B is plugged into the connecting base 20′. In doing so, the optical signal transmission is enabled between the cable member 15 and the waveguide device 31. In detail, as shown in FIG. 5E, at least part of the optical coupling member 30 is covered with the connecting base 20′ such that the end portions 151 are in optical alignment with the waveguide device 31 at the place covered with the connecting base 20′ so as to be protected by the connecting base 20′. Likewise, in other embodiment, an optical transmission apparatus 100 may include the optical cable 10, the connecting base 20 as shown in FIG. 3A, and the optical coupling member 30.

In addition, as shown in FIGS. 5C to 5E, since the waveguide device 31 has a complex optical waveguide channel structure, the detachable connection of the waveguide device 31 and the mounting base 33 allows them to be separately prepared from the photonic substrate 35 (also known as PIC), thus reducing the manufacturing time of the overall process of the optical coupling member 30. Furthermore, the cable member 15 is indirectly connected to the photonic substrate 35 through the mounting base 31, which prevents the photonic substrate 35 from being damaged by the direct impact of the plugging and unplugging force applied by the optical cable 10, making the optical cable 10 suitable for repeated plugging and unplugging.

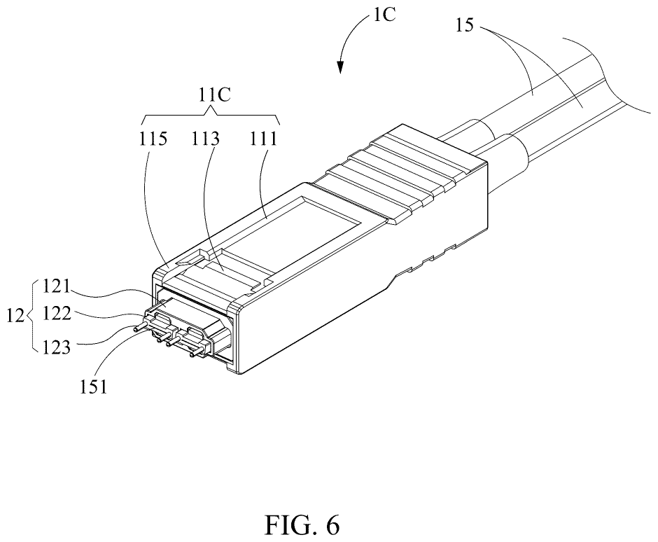

Referring to FIG. 6, which is a schematic structural view of an optical cable in another embodiment of the present application, as shown in FIG. 6, two cable members 15, a connecting base 20 (not shown for clarity of showing the coupling head 12), and a connecting member 11C cooperatively form an optical cable assembly 1C. Each of the cable members 15 is a multi-fiber cable including multiple optical fibers therein. In this embodiment, the connecting member 11C mainly differs from the connecting members 11 and 11B, as shown in FIGS. 3A and 4A, in that the connecting member 11C covers two ends of the two cable members 15, and the outer cover 121 of the coupling head 12 is configured for the arrangement of four positioning elements 123 and two ferrule elements 122. With the connecting member 11C, two cable members 15 can be optically connected to the optical coupling member 30 at a time, so that an area for the plugging of the connecting members can be reduced in terms of a spacing between adjacent ones of the connecting members.

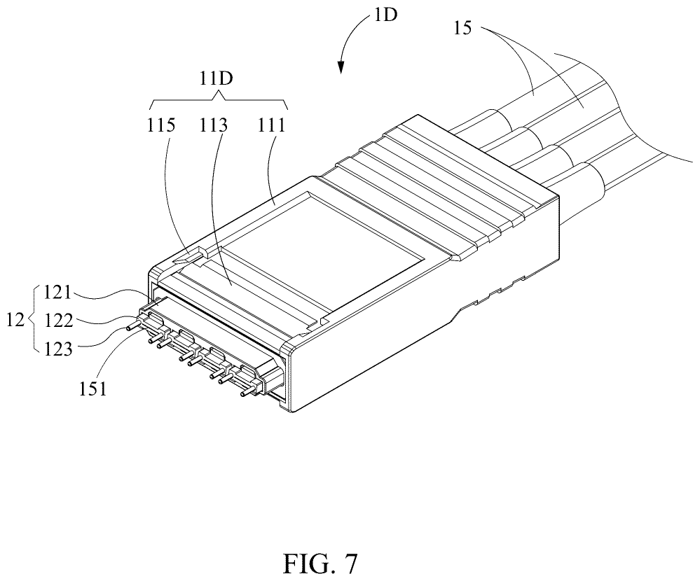

Referring to FIG. 7, in this embodiment, four cable members 15, a connecting base 20 (not shown for clarity of showing the coupling head 12), and a connecting member 11D cooperatively form an optical cable assembly 1D. In this embodiment, the connecting member 11D mainly differs from the connecting members 11, 11B, and 11C, as shown in FIGS. 3A, 4A, and 6 in that the connecting member 11D covers four ends of the four cable members 15, and the outer cover 121 of the coupling head 12 is configured for the arrangement of four ferrule elements 122 and eight positioning elements 123. With the connecting member 11D, four cable members 15 can be optically connected to the optical coupling member 30 at the same time, so that an area for the plugging of the connecting members can be further reduced in terms of a spacing between adjacent ones of the connecting members 11D.

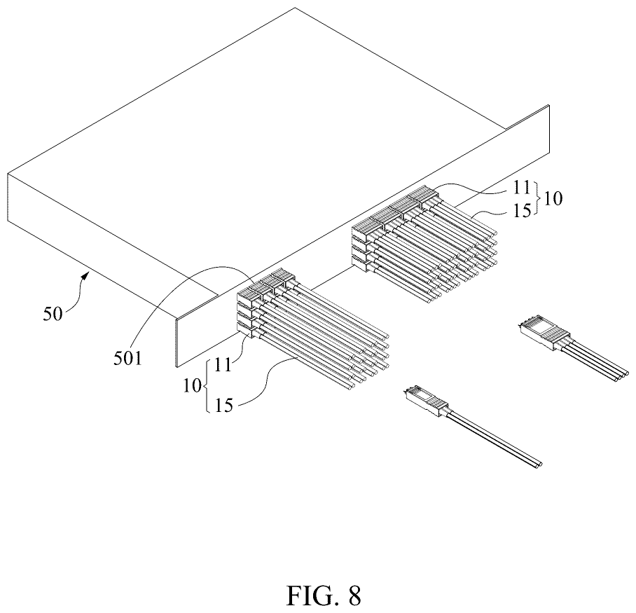

Referring to FIG. 8, which is a schematic structural view showing a plurality of optical cables 10 detachably connected to a mating device 50 in an embodiment of the present application, as shown in FIG. 8, the mating device 50 includes a plurality of the connection ports 501 arranged in rows and columns. In some embodiments, the connection ports 501 may be classified into at least two groups spaced apart from each other according to types of applied devices that are connected to the optical cables 10. The connection ports 501 of each row and column are arranged side by side to make the most of the side area of the mating device 50. In some embodiments, the mating device 50 may be installed in a switch or in a data center. As shown in FIG. 8, one of the groups of the connection ports 501 to which the optical cables 10 are connected is for the optical cable assembly 1C, and the other group is for the optical cable assembly 1D. Certainly, the connection ports 501 are also adapted to the optical cable assemblies 1A and 1B.

Referring to FIG. 9, it is a schematic structural view showing the optical cable 10 to be connected to the optical coupling member 30 disposed in the mating device 50. It should be noted that the connecting base 20 is illustrated with dashed lines for clarity of showing the internal components of the mating device 50, and a portion of an upper casing of the mating device 50 is omitted for clarity of showing the optical coupling member 30 disposed on a support board 51 installed inside the mating device 50. As shown in FIG. 9, the optical cable 10, the connecting base 20, and the optical coupling member 30 cooperatively form an optical transmission apparatus 100′. In this embodiment, four optical coupling members 30 are arranged on a same side of the support board 51, and four cable members 15 are arranged side by side with the connecting member 11 disposed at ends of the cable members 15. The coupling head 12 of the connecting member 11 is detachably engaged with the connecting base 20 and optically connected to the waveguide devices 31 of the four optical coupling members 30 at the same time, thereby enabling optical signal transmission between the optical coupling member 30 and the optical cable 10.

Accordingly, the optical cable assembly and the optical transmission apparatus in the embodiments of the present application provide the secure connection of the optical cable to the connecting base, thereby achieving reliable optical connection with the waveguide device and the photonic substrate. In addition, the configuration of the connection between the connecting member and the connecting base reduces the spacing between adjacent ones of the optical cable assemblies, thus overcoming the problem of the spacing limitation in prior art. Furthermore, the optical cable is indirectly coupled with the photonic substrate through the waveguide device and the mounting base, thereby preventing the photonic substrate from being damaged by the plugging and unplugging force and facilitating repeated plugging and unplugging of the optical cable.

Although the present invention has been disclosed as a preferred embodiment, it is not intended to limit the present invention. Those skilled in the art, without departing from the scope of the present invention, may make various changes or modifications, and thus the scope of the present invention shall be defined by the appended claims and their equivalents.

What is claimed is:

1. An optical cable, adapted to optically connect to a waveguide device, and comprising:
at least a cable member comprising a plurality of optical fibers and a cable jacket covering the optical fibers;
a coupling head positioned at end portions of the optical fibers in optical alignment with the waveguide device; and
a connecting member mounted to the cable member and covering part of the cable jacket, wherein the connecting member comprises a plurality of connecting walls and first fastening portions, the connecting walls are spaced apart from each other with respect to the coupling head, and the first fastening portions are disposed on the connecting walls, respectively.

2. The optical cable of claim 1, wherein the connecting walls are oppositely located at a top side and a bottom side of the connecting member, and the first fastening portions are arranged in a vertical direction with respect to the coupling head.

3. The optical cable of claim 1, wherein the connecting walls are oppositely located at a left side and a right side of the connecting member, and the first fastening portions are arranged in a horizontal direction with respect to the coupling head.

4. The optical cable of claim 1, wherein each of the connecting walls defines a connecting groove protruding inwardly from the connecting wall, and the first fastening portion protrudes outward from a surface of the connecting groove.

5. The optical cable of claim 4, wherein each of the connecting walls further defines two positioning slots arranged on opposite sides of the connecting groove and spaced apart from the first fastening portion.

6. The optical cable of claim 4, wherein the connecting groove extends in a direction in which the optical cable is optically connected to the waveguide device and defines a groove opening passing through an end of the connecting wall adjacent to the coupling head.

7. The optical cable of claim 6, wherein a width of the connecting groove is greater than half a width of the connecting wall.

8. An optical cable assembly, comprising the optical cable of claim 1 and a connecting base defining a fastening groove extending through the connecting base and comprising a fastening member disposed in the fastening groove, wherein the waveguide device is adapted to position between the connecting base and the coupling head, and the connecting member is detachably fastened with the fastening member in the fastening groove to optically connect the coupling head with the waveguide device.

9. The optical cable assembly of claim 8, wherein the fastening member comprises a pair of arm elements and a plurality of second fastening portions symmetrically formed on the arm elements to be detachably fastened with the first fastening portions.

10. The optical cable assembly of claim 8, wherein the optical cable comprises a plurality of the cable members, the coupling head comprises an outer cover and a plurality of ferrule elements covered with the outer cover, the optical fibers of each of the cable members are terminated at a corresponding one of the ferrule elements, part of the outer cover is housed in the connecting member, and another part of the outer cover extends out of the connecting member.

11. An optical transmission apparatus, comprising:
the optical cable assembly of claim 8, wherein the first fastening portions are detachably fastened with the fastening member; and
an optical coupling member comprising a waveguide device positioned to correspond to the fastening groove and configured in optical connection with the optical fibers.

12. The optical transmission apparatus of claim 11, wherein the optical coupling member further comprises a mounting base comprising a positioning groove extending through part of the mounting base, and the waveguide device is positioned in the positioning groove.

13. The optical transmission apparatus of claim 11, wherein the connecting walls are oppositely located at a top side and a bottom side of the connecting member, and the first fastening portions are arranged in a vertical direction with respect to the coupling head.

14. The optical transmission apparatus of claim 11, wherein the connecting walls are oppositely located at a left side and a right side of the connecting member, and the first fastening portions are arranged in a horizontal direction with respect to the coupling head.

15. The optical transmission apparatus of claim 11, wherein each of the connecting walls defines a connecting groove protruding inwardly from the connecting wall, and the first fastening portion protrudes outward from a surface of the connecting groove.

16. The optical transmission apparatus of claim 15, wherein each of the connecting walls further defines two positioning slots arranged on opposite sides of the connecting groove and spaced apart from the first fastening portion.

17. The optical transmission apparatus of claim 15, wherein a width of the connecting groove is greater than half a width of the connecting wall.

18. The optical transmission apparatus of claim 11, wherein the fastening member comprises a pair of arm elements and a plurality of second fastening portions symmetrically formed on the arm elements to be detachably fastened with the first fastening portions.

19. The optical transmission apparatus of claim 11, wherein the optical cable comprises a plurality of the cable members, the coupling head comprises an outer cover and a plurality of ferrule elements covered with the outer cover, the optical fibers of each of the cable members are terminated at a corresponding one of the ferrule elements, part of the outer cover is housed in the connecting member, and another part of the outer cover extends out of the connecting member.

20. An active optical transceiver comprising the optical transmission apparatus of claim 11, a housing, and a load board disposed in the housing, wherein the waveguide device is positioned on the load board, and part of the optical transmission apparatus is disposed in the housing.
